(19) United States
(12) Patent Application Publication
(10) Pub. No.: US 2017/0272362 A1
(43) Pub. Date: Sep. 21, 2017

(54) DATA COMMUNICATION SYSTEMS AND METHODS OF OPERATING DATA COMMUNICATION SYSTEMS

(71) Applicant: Adbrain Ltd, London (GB)

(72) Inventors: Jason Atlas, London (GB); Seiyang Chua, London (GB); Pourya Saber, London (GB); Ashley Timothy Abraham, London (GB)

(21) Appl. No.: 15/073,717

(22) Filed: Mar. 18, 2016

(51) Int. Cl. H04L 12/801; H04L 29/08

(52) U.S. Cl. CPC H04L 47/10; H04L 67/02

(57) ABSTRACT

The present disclosure provides a data communication system and methods of controlling data flows within a data communication system. The data communication system includes a data communication network to which users are coupled when the data communication system is in operation. The data communication system also includes a data server. The users have associated user identifiers, and can interact with the system via user devices. The method includes: receiving the user identifiers; determining matched pairs of the user identifiers; comparing the matched pairs of the user identifiers with each of the received user identifiers, and determining a similarity score for the matched pairs and the user identifiers; mapping the user identifiers onto at least one single customer view identifier, each customer view identifier is distinctly mapped to user identifier(s) for generating a mapping function; and using the mapping function for selectively controlling distribution of data content to the users.

### TECHNICAL FIELD

The present disclosure relates to data communication systems, and also to methods of operating aforesaid data communication systems; for example, the present disclosure relates to data communication systems employing data mining, wherein the data mining involves creating non-overlapping groups of user identifiers representing a single user. Moreover, the present disclosure discloses methods of operating data communication systems for controlling data flows to multiple users that are coupled via data communication networks of the aforesaid data communication systems.

### BACKGROUND

Recently, there has been a rapid increase in the number of users connecting to data communications networks such as, for example, the Internet®, for performing various user activities. The user activities include, for example, social networking, executing e-commerce transactions, communicating data, providing and/or receiving entertainment, and so forth. For example, a given user can connect to a given data communication network and access information therefrom, for example data content, using multiple devices coupled to the given data communication network, wherein the multiple devices are located at mutually different spatial locations. Nowadays, many data mining companies analyze and utilize data pertaining to activities of users coupled to the Internet® in order to derive substantial information relating to personalities of the users, spatial locations of the user, shopping preferences of the users, personal interests of the users, trends associated with the users, and so forth. Such analyzed data, namely information, assists the data mining companies to plan customer-centric marketing strategies, such as targeted advertising campaigns, targeting a specific demographic area, targeting a group of users, providing improvements in data communication network data delivery performance, providing technical data processing improvements, and so forth. As a result of a given same user accessing the Internet® using multiple devices, there may result redundant user activity data in respect of mutually different user devices; the size of user activity data increases substantially, though it is not of much relevance to data mining companies for identifying trends, and user preferences in comparison to multiple devices' data is of a single user only. An ability to identify and present to individuals or organizations a probabilistic graph of user profile is a nascent field, with considerable activity presently being expended to improve such ability. Both technology and approaches for generating such probabilistic graphs pertaining to these very well understood problems, from marketing and advertisement technology (“ad tech), to media and entertainment/connected homes, to the Internet® of Things, all depend on having an unambiguous understanding of what devices coupled via use of Internet Protocol are associated with a given user, in order to create a unified identity for the given user. The concept of identity on the Internet® has largely been established through an explicit process of authentication, which allows applications and services to have explicit identification relationships as a given user moves between multiple devices that are couplable to the Internet®.

Presently, there exist many techniques for analyzing operating data of mutually different devices and data related to network usage by one or more users to identify identification relationships between the one or more users and the mutually different devices. The techniques for analyzing and/or determining the identification relationships are based primarily around authentication of user credentials such as, but not limited to, a login identifier, a login password, and so forth. Every device connected to the network has an associated Internet Protocol (IP) address. Other than the IP address, every device also has a unique device identifier such as, an International Mobile Equipment Identity (IMEI).

For accessing the Internet®, a given user may use a web browsing application such as, but not limiting to, the Internet Explorer®, Google Chrome®, and the like for accessing various websites. Some websites save cookies or browsing history of the given user. The cookies may include a fragment of text or information sent to the web browsing application while the given user is accessing a given user-selected website. Various models to calculate a probability of a same given user accessing the Internet® through multiple devices are based on IP address identification and use of cookies. Many existing techniques use cookies to identify various relationships such as, a relationship between various activities of the user, a relationship of the user with multiple devices, and so forth. However, determination of such relationships across multiple websites using cookies may present privacy concerns for the users.

Furthermore, every user connected to a data communication network such as the Internet® has a digital identity including online information related to the user. Certain methods of analyzing the digital identity also involve scrutinizing Internet® usage data for all the devices using a same given IP address. The techniques that adopt the analysis of Internet® usage frequency count across multiple devices may be highly inaccurate, since a given user may not make use of the given user's devices equally. There also exist methods that utilize the browsing history, including consistency or frequency of access to similar websites across multiple devices by the users, to determine user identity.

In view of the preceding, there is a problem that contemporary techniques for identifying users, or mapping users onto multiple devices in a given data communication network, are not sufficiently developed and versatile. Moreover, there arises a further problem with accuracy of such aforementioned contemporary techniques.

### SUMMARY

The present disclosure seeks to provide methods, systems, and computer program products involving data mining.

Moreover, the present disclosure further seeks to provide systems and methods that utilize improved techniques for probabilistic true mapping of unique users to IP-based devices.

The present disclosure seeks to provide a device graph clustering process for disambiguating differentiated algorithms into a normalized process for visualization and data mining purposes.

In an aspect of the present disclosure, a method of controlling data flows within a data communication system is disclosed.

In another aspect of the present disclosure, a data communication system for controlling data flows is disclosed.

In further aspect of the present disclosure, a non-transitory tangible computer readable medium comprising instructions for controlling data flows is disclosed.

In another aspect of the present disclosure, a method of identifying relationships between a number of users and a number of devices connected to a network is disclosed.

In yet another embodiment, a system for identifying relationships between a plurality of users and a plurality of devices connected to a network is disclosed.

According to an aspect of the present disclosure, there is provided a method of controlling data flows within a data communication system, wherein the data communication system includes a data communication network to which a plurality of users are coupled when the data communication system is in operation, wherein the data communication system includes at least one data server for use in implementing the method, wherein the plurality of users have associated therewith corresponding user identifiers (IDs), and wherein the plurality of users interact with the data communication system by using a plurality of user devices, wherein the method comprises steps of:

(i) receiving the plurality of user identifiers (IDs);

(ii) determining a plurality of matched pairs (P) of the user identifiers (IDs);

(iii) comparing the determined plurality of the matched pairs (P) of the user identifiers (IDs) with each of the received plurality of user identifiers (IDs), and determining a similarity score for the matched pairs and the user identifiers (IDs);

(iv) mapping the plurality of user identifiers (IDs) onto at least one single customer view identifier (SCV_ID), wherein each single customer view identifier (SCV_ID) is distinctly mapped to at least one user identifier (ID) of the plurality of user identifiers (IDs), to generate a mapping function (F); and

(v) using the mapping function for selectively controlling distribution of data content to the plurality of users.

According to another aspect of the present disclosure, there is provided a data communication system for controlling data flows, wherein the data communication system includes a data communication network to which a plurality of users are coupled when the data communication system is in operation, wherein the data communication system includes at least one data server for use in implementing the method, wherein the plurality of users have associated therewith corresponding user identifiers, and wherein the plurality of users interact with the data communication system by using a plurality of user devices, wherein the data communication system is operable to:

(i) receive the plurality of user identifiers;

(ii) determine a plurality of matched pairs of the user identifiers;

(iii) compare the determined plurality of the matched pairs of the user identifiers with each of the received plurality of user identifiers, and determining a similarity score for the matched pairs and the user identifiers;

(iv) map the plurality of user identifiers onto at least one single customer view identifier, wherein each customer view identifier is distinctly mapped to at least one user identifier of the plurality of user identifiers, to generate a mapping function; and

(v) use the mapping function for selectively controlling distribution of data content to the plurality of users.

According to another aspect of the present disclosure, there is provided a method of identifying relationships between a plurality of users and a plurality of devices connected to a network, the method comprising:

at a server:
receiving, by a transceiving module, a plurality of user identifiers (IDs) associated with the plurality of users present in the network;
determining, by a data retrieving module, a plurality of matched pairs of user identifiers;
comparing, by an identity mapping module, the determined plurality of matched pairs of user identifiers with each of the received plurality of user identifiers to create a first graph, wherein the first graph comprises one or more of the plurality of matched pairs of user identifiers overlapped with the received plurality of user identifiers and a similarity score, wherein the similarity score is determined based on the comparison of the matched pairs of user identifiers with the plurality of user identifiers;
mapping, by the identity mapping module, the plurality of user identifiers of the first graph onto at least one single customer view identifier, wherein each distinct single customer view identifier is mapped to at least one user identifier of the plurality of user identifiers;
creating, by the identity mapping module, a second graph based on the mapping of the plurality of user identifiers of the first graph onto the at least one single customer view identifier, the second graph comprises a plurality of single customer view identifiers, wherein each single customer view identifier of the plurality of single customer view identifiers in the second graph represent a single user and one or more user identifiers mapped to the single customer view identifier belongs to same user of the plurality of users; and
identifying, by the identity mapping module, at least one user associated with one or more of the plurality of computing devices based on the plurality of single customer view identifiers in the second graph, wherein the at least one single customer view identifier comprises browsing event including at least one of browsing history, timestamp information, images, uniform resource locators, images, cookie information, and device identifier.

According to another aspect of the present disclosure, there is provided a system for identifying relationship between a plurality of users and a plurality of devices connected to a network, the system comprising:

a server comprising:
a transceiving module configured to receive a plurality of user identifiers (IDs) associated with the plurality of users present in the network;
a data retrieving module configured to determine a plurality of matched pairs of user identifiers; and
an identity mapping module configured to:
   compare the determined the plurality of matched pairs of user identifiers with each of the received plurality of user identifiers to create a first graph, wherein the first graph comprises one or more of the plurality of matched pairs of user identifiers overlapped with the received plurality of user identifiers and a similarity score, wherein the similarity score is determined based on the comparison of the matched pairs of user identifiers with the plurality of user identifiers;
   map the plurality of user identifiers of the first graph onto at least one single customer view identifier, wherein each distinct single customer view identifier is mapped to at least one user identifier of the plurality of user identifiers;
   create a second graph based on the mapping of the plurality of user identifiers of the first graph onto the at least one single customer view identifier, the second graph comprises a plurality of single customer view identifiers, wherein each single customer view identifier of the plurality of single customer view identifiers in the second graph represent a single user and one or more user identifiers mapped to the single customer view identifier belongs to same user of the plurality of users; and
   identify, by the identity mapping module, at least one user associated with one or more of the plurality of computing devices based on the plurality of single customer view identifiers in the second graph, wherein the at least one single customer view identifier comprises browsing event including at least one of browsing history, timestamp information, images, uniform resource locators, images, cookie information, and device identifier.

### BRIEF DESCRIPTION OF THE FIGURES

The foregoing summary, as well as the following detailed description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIGS. 1A-1C illustrate various exemplary data communication systems, in accordance with various embodiments of the present disclosure, wherein:

FIG. 2 illustrates a block diagram of a server (or data server), in accordance with an embodiment of the present disclosure;

FIG. 3 illustrates a block diagram of a computing device (or a user device), in accordance with an embodiment of the present disclosure;

FIG. 4 is a flowchart illustrating an exemplary method for creating non-overlapping groups of user identifiers representing a single user, in accordance with an embodiment of the present disclosure; and

FIG. 5 is a flowchart illustrating an exemplary method for selectively controlling distribution of data to a number of users in a data communication network, in accordance with an embodiment of the present disclosure.

### DETAILED DESCRIPTION

Description of embodiments of the present disclosure is not intended to limit the scope of claims of the present disclosure. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Functional units described in this disclosure have been labeled as systems or devices. A module, device, or a system may be implemented in programmable hardware devices such as, processors, digital signal processors, central processing units, field programmable gate arrays, programmable array logic, programmable logic devices, cloud processing systems, or the like. The devices/modules may also be implemented in software for execution by various types of processors. An identified device/module may include executable code and may, for example, comprise one or more physical or logical blocks of computer instructions, which may, for example, be organized as an object, procedure, function, or other construct. Nevertheless, the executable of an identified device/module need not be physically located together, but may comprise disparate instructions stored in different locations which, when joined logically together, comprise the device and achieve the stated purpose of the device.

Indeed, an executable code of a device could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

In various embodiments of the present disclosure, definitions of one or more terms that will be used as provided below.

As used herein, a “computing device” or user device includes a single device or a combination of multiple devices, which may be capable of communicating, and exchanging one or messages with other devices present in a network.

As used herein, a “User Interface” or a “Graphical User Interface” (GUI) can include an interface on a display, such as a screen, of the computing device enabling a user to interact with the device or computing device.

Further, as used herein, a “database” refers to a single or multiple modules or devices including hardware, software, firmware, or combination of these that can be configured to store user identifiers, matched pairs of the user identifiers, device identifiers, browsing history of the users, browsing events including browsing history of the users on various devices, and so forth.

Furthermore, as used herein, an “Input/Output module” refers to a single or multiple modules or devices including hardware, software, firmware, or combination of these that can be configured to receive an input from a user or to present an output to the user.

Further, as used herein, a “memory” refers to a single or multiple modules or devices including hardware, software, firmware, or combination of these that can be configured to store instructions that can be executed by other modules/devices.

As used herein, a “central processing unit” refers to a single or multiple modules or devices including a software, hardware, firmware or combination of these, that is configured to execute instructions stored in the memory.

As used herein, a “data communication system” refers to a network of devices and/or users. The data communication system may include a data communication network to which a number of users are coupled when the data communication system is in operation. The data communication network may include a data server. Each of the users has an associated user device to connect to the data communication network.

It will be appreciated that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

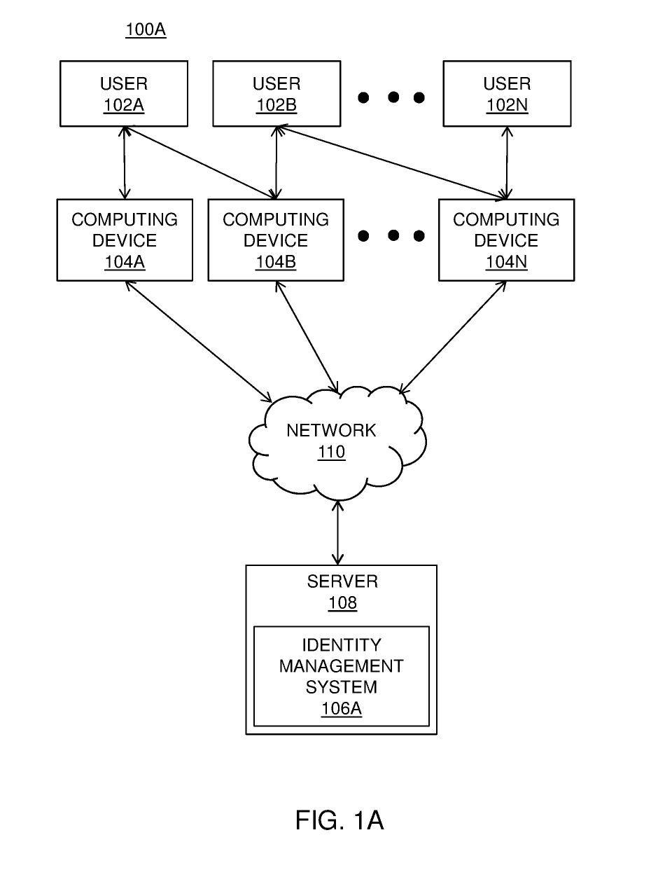

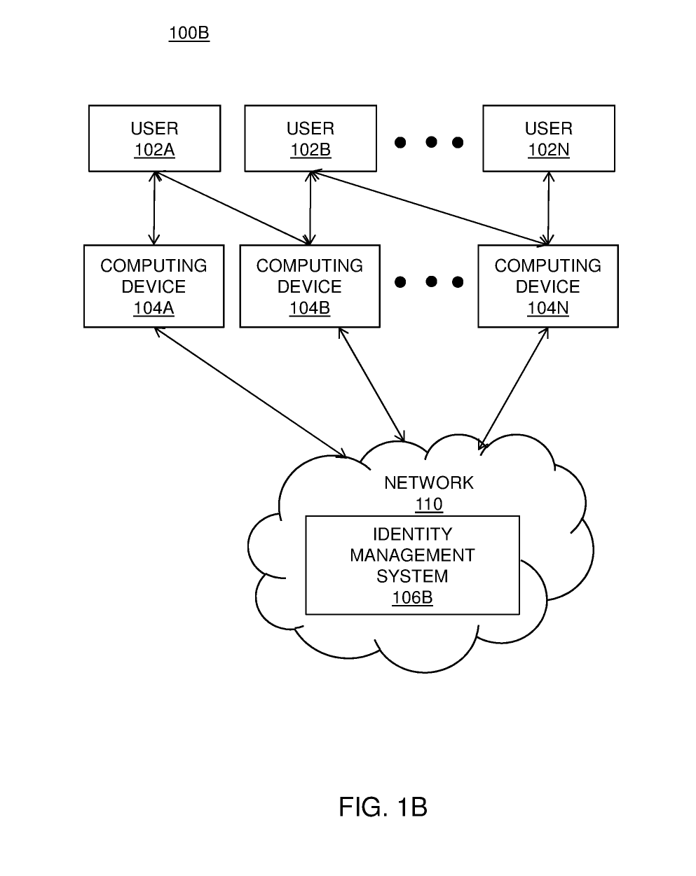

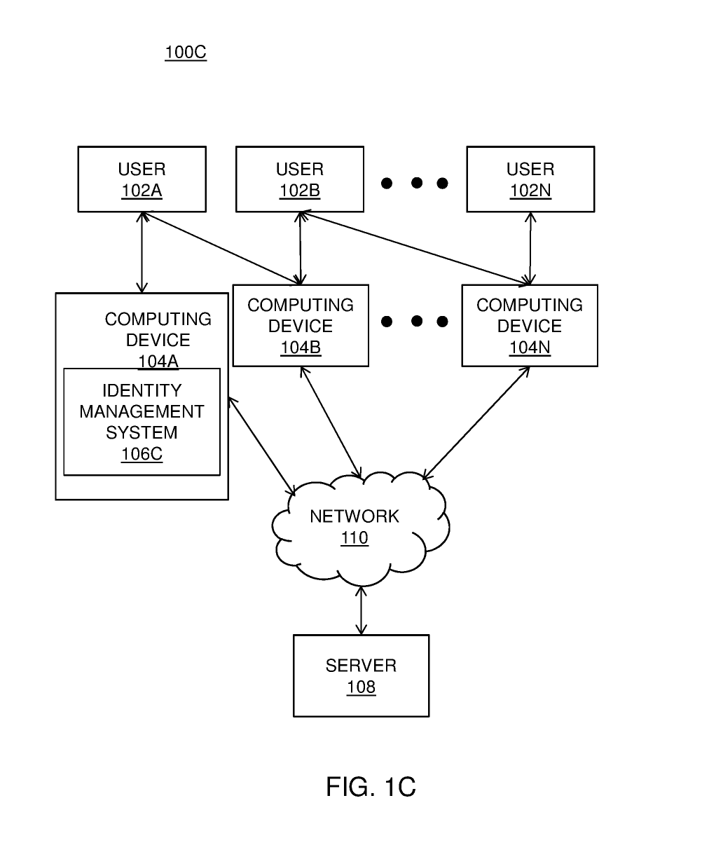

In FIGS. 1A-1C, there are illustrated data communication systems 100A-100C, in accordance with various embodiments of the present disclosure. As shown in FIG. 1A, the data communication system 100A primarily includes a plurality of computing devices (or user devices) 104A-104N associated with a plurality of users 102A-102N. In describing embodiments of the present disclosure, the terms “user device” and “computing device” are used interchangeably on account of mutual similarities in their functionality and structure. Moreover, each of the users 102A-102N may connect to a network 110 (also referred as a data communication network 110) for accessing information using their associated computing devices 104A-104N. In an embodiment, the users are coupled to the data communication network 110 when the data communication system is in operation. Each of the computing devices 104A-104N also has an associated device identifier. An example of the device identifier may include an International Mobile Equipment Identity (IMEI).

In an embodiment, a given user of the plurality of users 102A-102N uses more than one computing device for accessing the network 110 by using same or different user IDs. For example, the user 102A can use the computing device 104A and the computing device 104B for accessing the network 110. Similarly, the user 102B can use computing device 104B and 104N for accessing the network 110. Moreover, each of the users 102A-102N may have more than one associated user IDs. Examples of the user identifiers may include such as, but not limited to, a login identifier (ID), a password, a phone number, an image identifier, a name, date of birth of a user, and so forth.

Examples of the computing devices 102A-102N include cell phones, phablet computers, tablet computers, desktop computers, a personal digital assistant (PDA), and so forth. A typical example of the computing device is a wireless data access-enabled device, for example, an iPHONE® smart phone, a BLACKBERRY® smart phone, a NEXUS ONE™ smart phone, an iPAD® device, and so forth, that is capable of sending and receiving data in a wireless manner using protocols like the Internet Protocol, or IP, and the wireless application protocol, or WAP. Hereinafter, the terms network and data communication network are used interchangeably without change in their meaning due to similarity in their functionality and structure.

Furthermore, the computing devices 102A-102N may be connected to the network 110 using wired or wireless technologies. Examples of the network 110 may include, such as, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet®, second generation (2G) telecommunication networks, third generation (3G) telecommunication networks, fourth generation (4G) telecommunication networks, and Worldwide Interoperability for Microwave Access (WiMAX) networks. Furthermore, the terms network and data communication network are used interchangeably throughout this draft due to similarilty in their structure and functionality.

The data communication system 100A also includes a server 108 (or a data server 108) connected to the network 110. Furthermore, the terms server and data server are used interchangeably without change in their meaning due to similarity in their functionality and structure. The server 108 further includes an identity management system 106A. The identity management system 106A is operable to identify and establish relationship between the users 102A-102N and the computing devices 104A-104N connected to or present in the network 110. In an embodiment, the identity management system 106A is operable to identify and establish relationship between the users 102A-102N and the computing devices 104A-104N based on browsing events including such as, but not limiting to, browsing history, timestamp information, website information, uniform resource locators, device identifiers, images, and so forth.

The identity management system 106A is operable, namely configured, to receive a number of user identifiers (IDs) associated with the plurality of users 102A-102N present in the data communication network 110. The identity management system 106A is further configured to determine a number of matched pairs of user identifiers. In an embodiment, the matched pairs of user identifiers are pre-defined and pre-stored in a database of the server 108. In an embodiment, the user identifiers are received from one of the computing devices 104A-104N. In an embodiment, the matched pairs of the user identifiers are pre-stored in a database using a Parquet format or a file system. The storing of the matched pairs in Parquet format may maintain integrity of the associations and meta-information in information, for example a first graph or a second graph, displayed to the users 102A-102N. The Parquet format is a column oriented binary file format, which is considered to be very efficient for storing large scale data and executing queries.

Furthermore, the data communication system and primarily the identity management system 106A are operable, namely are configured, to compare the determined matched pairs (P) of the user identifiers (IDs) with each of the received user identifiers (IDs). The identity management system 106A is also configured to determine a similarity score for the matched pairs and the user identifiers. In an embodiment, the similarity score for the matched pairs and the user identifiers may have a numeric value for example, in a range of 0 to 1. Furthermore, the similarity score may indicate a probability of two or more user IDs being associated with one user based on a mapping of the matched pairs and the user identifiers. For example, the value of the similarity score is “1” if there is 100 percent probability and the value of the similarity score is “0” is probability is zero. In another embodiment, the similarity score value may be selected from the following: “High”, “Low”, “Very Low”, and “Very High”. An identity management system 106A may further set a pre-defined minimum and maximum probability threshold. For example, the minimum probability threshold is 0.1, the maximum probability threshold is 0.9, then if the probability is below 0.1 then the similarity score is “Very Low”, and when the probability is more than 0.9, then the similarity score while comparing the user IDs is “Very High”. The similarity score may be determined by using suitable methods such as, but not limited to, methods based on correlation, neural network methods, multi-dimensional correlation, clustering methods, Kalman Filtering, regression based methods, association rule learning methods, dependency modeling, anomaly detection, outlier/change/deviation detection methods, summarization methods, classification methods, and so forth. In an embodiment, in of cluster analysis, a similarity score is determined by using the following equation:

s(x,y)=−∥x−y∥₂²

where ∥x−y∥₂² is the Euclidean distance.

In another embodiment, similarity score may be determined using cosine similarity for real-valued vectors, as used for retrieving information for scoring similarity between documents in a vector space model. Depending on the stage on the graph creation, the cosine method is used, and may be enhanced by using cluster analysis methods. This way, the similarity scores, and the associations and their respective “strengths” may be determined. The following exemplary cosine equation may be used to determine the similarity score:

D_{C}(A,B)=1−S_{C}(A,B)

Further, the cosine equation can be normalized with cluster analysis methods to handle lack of triangulation in the cosine.

The identity management system 106A is also operable, namely configured, to map the user identifiers onto at least one single customer view identifier (SCV_ID). A single customer view ID may be based on browsing event including browsing history, timestamp information, uniform resource locators, website information, device ID and so forth. The browsing event may include information monitored by or collected from various devices or software applications such as, but not limiting to, routers, gateways, computing devices 104A-104N, data monitoring software, in the network 110. Such collection of information is achieved by analyzing DNS (digital network signaling) routing information of data packets conveying a data payload, irrespective of whether or not the payload is encrypted. The SCV_ID may also indicate a linking of a user identity or user identifier to a device (or device identifier). Further, the identity can be an internet protocol (IP) address or any other unique Data/networking element or device, that can be mapped to all the other devices and systems associated with the user, for example, user 102B. Furthermore, multiple users may be mapped onto a single SCV_ID. The single SCV_ID may represent and indicate that the multiple users IDs that are being mapped onto the same SCV_ID belong to a same user. Further, an SCV_ID represent a single user and one or more user identifiers mapped to the SCV_ID belongs to same user of the users 102A-102N. Each single customer view identifier is distinctly mapped to at least one user identifier of the user identifiers, to generate a mapping function “F”. A distinct SCV_ID represent a single unique user and may be based on the browsing event across multiple devices 104A-104N. The mapping function “F” may be determined using suitable analysis methods and/or computational methods based on correlation, neural network methods, multi-dimensional correlation, clustering methods, Kalman Filtering, regression based methods, association rule learning methods, dependency modeling, anomaly detection, outlier/change/deviation detection methods, summarization methods, classification methods, and so forth, as aforementioned.

In an exemplary scenario, the mapping function “F” may be determined using multidimensional correlation method and model to identify relationships between the user devices 104A-104N, single customer view IDs and the user identifiers of the users 102A-102N. The identity management system 106A is also operable, namely configured, to use the mapping function for selectively controlling distribution of data content to the users 102A-102N. In an example embodiment, the data content is presented on associated user devices 104A-104N of the users 102A-102N. Examples of the data content may include, such as, but not limited to, advertisements, surveys, entertainment data like movies, songs, news, and so forth. In an embodiment, the identity management system 106A is configured to repeat, for example iteratively, the process of comparing the determined matched pairs of the user identifiers with each of the received user identifiers and determining the similarity scores, and mapping the user identifiers onto at least one single customer view identifier for achieving a distinct mapping in the mapping function “F”. The mapping function “F” may indicate relationship of the user IDs and various device identifiers of the user devices that are being used for accessing the data communication network by multiple users.

In an example embodiment, the identity management system 106A is operable, namely configured, to compare the determined matched pairs of user identifiers with each of the received user identifiers to create a first graph. The first graph may include one or more of the matched pairs “P” of user identifiers overlapped with the received user identifiers and a similarity score. The similarity score may be determined based on the comparison of the matched pairs of user identifiers with the received user identifiers.

The identity management system 106A is further configured to map the user identifiers of the first graph onto at least one single customer view identifier. Each distinct SCV_ID is mapped to at least one user identifier of the user identifiers. The identity management system 106A is further operable, namely configured, to create a second graph based on the mapping of the user identifiers of the first graph onto the at least one single customer view identifier. The second graph may include a number of SCV_IDs. In some embodiments, one or more of the single customer view identifiers are in the received user identifiers. In alternative embodiment, one or more of the user identifiers mapping to a same single customer view identifier are absent in the second graph. In an embodiment, the second graph is empty when there is not enough information about the user identifiers, or the user identifiers are found not to have a mapping to another device. In another embodiment, the second graph is an empty graph when the identity management system 106A determines that some of the user IDs are bots, or suspicious. This may avoid giving false positives in the second graph. In an alternative embodiment, the single graph includes at least one singleton match, thereby eliminating empty graphs.

Furthermore, the identity management system 106A is configured to present or display the second graph on a computing device such as the computing device 104B of the user 102B. For example, the second graph or an output graph may be presented on the computing device 104A of the user 102A. In an embodiment, an SCV_ID in the second graph represent a single user and one or more user identifiers mapped to the SCV_ID belongs to same user of the users 102A-102N. In an embodiment, one or more of the user identifiers mapping to a same SCV_ID are absent in the second graph.

Furthermore, the identity management system 106A is operable, namely configured, to identifying at least one user associated with one or more of the computing devices 104A-104N based on the single customer view identifiers in the second graph. A single customer view identifier of the multiple single customer view identifiers in the second graph may represent a single user and one or more user identifiers mapped to the single customer view identifier belongs to a same user of the multiple users 102A-102N.

As shown in FIG. 1B, an identity management system 106B may be present in a cloud network 110 or on any network device in the network 110.

Furthermore, in an embodiment, an identity management system 106C may be present on a computing device itself. For example, the identity management system 106C may be present on the computing device 104A as shown in FIG. 1C. The functionality of the identity management systems 106B-106C is similar to the identity management device 106A as described in the foregoing with reference to FIG. 1A.

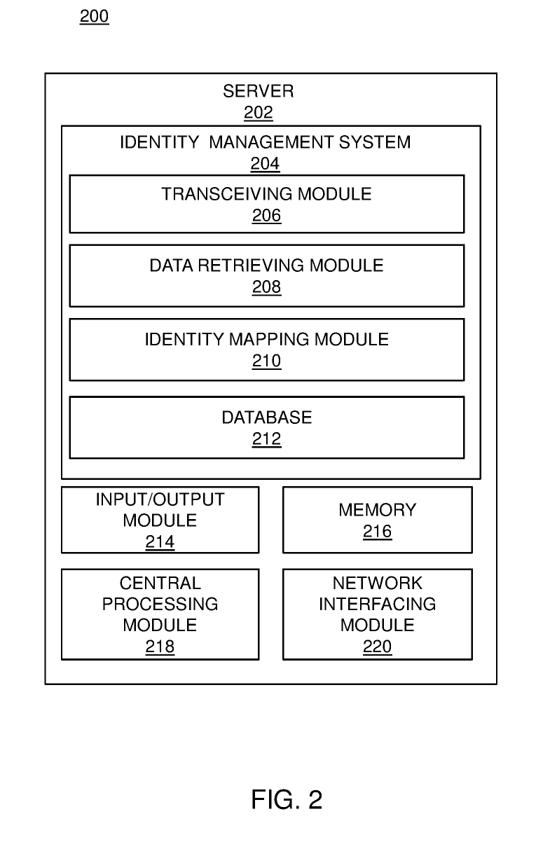

In FIG. 2, there is shown a block diagram 200 of a server 202, in accordance with an embodiment of the present disclosure. As shown, the server 202 primarily includes an identity management system 204, an Input/Output module 214, a memory 216, a central processing module or unit (CPU) 218, and a network interfacing module 220. The server 202 may be a single device or may include more than one devices including software, hardware, firmware, or combination of these. The system or modules of the server 202 may be individual device or combination of devices capable of performing one or more functions.

The identity management system 204 is operable, namely configured to identify a relationship between a number of users (such as the users 102A-102N) and a number of devices (such as the computing devices 104A-104N) connected to the network 110 (or a data communication network 110). The identity management system 204 includes a transceiving module 206, a data retrieving module 208, an identity mapping module 210, and a database 212. The transceiving module 206 is configured to receive a number of user identifiers (IDs) associated with a number of users (such as the users 102A-102N) present in a network (such as the network 110).

The data retrieving module 208 is configured to determine a number of matched pairs of user identifiers, for example to determine a plurality of such matched pairs. In an embodiment, the matched pairs of user identifiers are pre-defined and pre-stored in a database of the server 202 or of a remotely located device in the network 110. In an embodiment, the data retrieving module 208 is operable, namely configured, to retrieve the matched pairs of user identifiers from the database 212.

The identity mapping module 210 is operable, namely configured, to compare the determined matched pairs of user identifiers with each of the received user identifiers and determine a similarity score for the matched pairs and the user identifiers (IDs or UIIDs). The identity mapping module 210 is also operable, namely configured, to map the user identifiers onto at least one single customer view identifier (SCV_ID). Each single customer view identifier is distinctly mapped to at least one user identifier of the received user identifiers to generate a mapping function “F”.

The identity mapping module 210 is operable, namely configured, to use the mapping function for selectively controlling distribution of data content to the users 102A-102N. In an embodiment, the transceiving module 206 of the server 202 may send the mapping to another device or server in the network 110. Furthermore, the another server may control distribution of data content to the users in the network based on the received mapping function and SCV_IDs. For example, if a user John is attached to four computing devices like laptop, phones and so forth. then the server may decide to send content, such as a survey or an advertisement, to only one of the devices associated with John, for example to conserve data communication bandwidth, network energy consumption, to reduce data communication network response latency, and so forth.

In an embodiment, the identity mapping module 210 is operable, namely configured, to compare the determined matched pairs of user identifiers with each of the received user identifiers to create a first graph. The first graph may include one or more of the matched pairs of user identifiers overlapped with the received user identifiers and a similarity score. The similarity score may be determined based on the comparison of the matched pairs of user identifiers with the received user identifiers. In an embodiment, the user identifiers are received from one of the computing devices 104A-104N.

The identity mapping module 210 is further operable, namely configured, to map the user identifiers of the first graph onto at least one single customer view identifier. Each distinct SCV_ID is mapped to at least one user identifier of the user identifiers. The identity mapping module 210 is further operable, namely configured, to create a second graph based on the mapping of the user identifiers of the first graph onto the at least one single customer view identifier (SCV_ID). The second graph may include a number of SCV_IDs. The single customer view ID may be based on browsing event including browsing history, timestamp information, images, uniform resource locators, images, cookie information, and device identifier monitored from devices such as routers, monitoring applications in the network 110. In an embodiment, the second graph includes the SCV_IDs such that one or more of the SCV_IDs are in the received user identifiers. In another embodiment, one or more of the user identifiers that are mapping to a same SCV_ID are not in the second graph. A single customer view identifier of the plurality of single customer view identifiers in the second graph represent a single user, and one or more user identifiers mapped to the single customer view identifier belong to a same given user of the users 102A-102N.

The identity mapping module 210 is also operable, namely configured, to identify at least one user associated with one or more of the computing devices 104A-104N based on the single customer view identifiers in the second graph. For example, if there are four SCV_IDs “A”, “B”, “C”, and “D” and there are eight user IDs i.e., “John”, “Tim”, “Ross”, “Sara”, “Rachel”, “Joey”, “Monica”, and “Jack”. Based on the mapping function “F” and in the second graph if “John”, “Tim”, “Sara” are mapped to the SCV_ID “A”, this means that the user IDs “John”, “Tim”, “Sara” belongs to same user. This may help the server 202 to control distribution of content such as advertisements, surveys, movies, songs, etc. to the one or more of the users 102A-102N. For example, the server 202 may send content to only one computing or user device associated with the three user IDs “John”, “Tim”, and “Sara”.

Moreover, the transceiving module 206 is operable, namely configured, to send to or present the second graph on a computing device of a user. For example, the second graph or an output graph may be presented at the computing device 104A of the user 102A. In an embodiment, an SCV_ID of the plurality of SCV_IDs in the second graph represent a single user. Furthermore, one or more user identifiers mapped to the SCV_ID belongs to same user of the plurality of users 102A-102N. Furthermore, as used herein, a “memory” refers to a single or multiple modules or devices including hardware, software, firmware, or combination of these that can be configured to store instructions that can be executed by other modules/devices.

The central processing module 218 may include a single or multiple modules or devices including a software, hardware, firmware or combination of these, that is configured to execute instructions stored in the memory 216. The network interfacing module 220 may enable the server 202 to establish connection with the network 110 or/and with other network devices such as the computing devices 104A-104N present in the network 110. The network 110 may include Internet®.

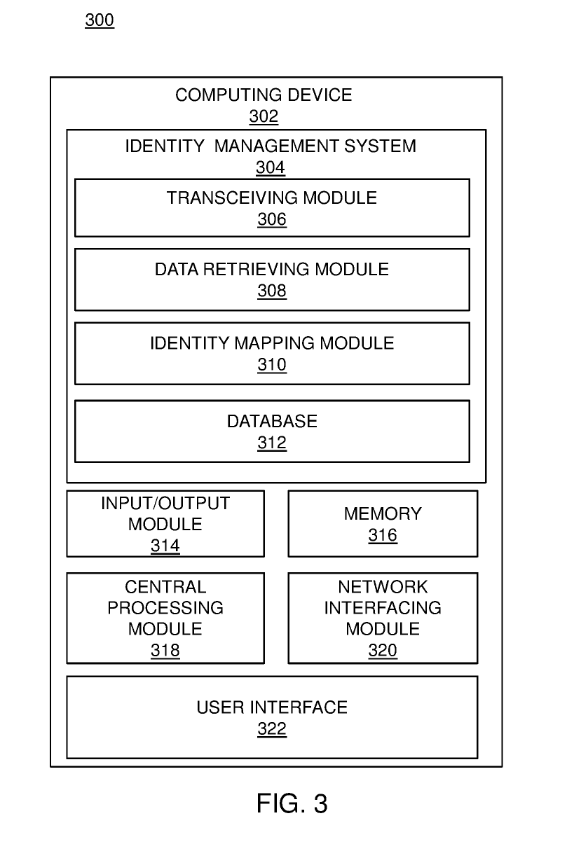

In FIG. 3, there is provided an illustration of a block diagram 300 that represents a computing device 302, in accordance with an embodiment of the present disclosure. As shown, the computing device 302 primarily includes an identity management system 304, an input/output module 314, a memory 316, a central processing module or unit (CPU) 318, and a network interfacing module 320. Furthermore, the computing device 302 may include software, hardware, firmware, or combination of these. The system or modules of the computing device 302 may be individual device or combination of devices capable of performing one or more functions as described below.

The identity management system 304 is operable, namely configured, to identify a relationship between a number of users (such as the users 102A-102N) and a number of devices (such as the computing devices 104A-104N) connected to the network 110. The identity management system 304 includes a transceiving module 306, a data retrieving module 308, an identity mapping module 310, and a database 312. The transceiving module 306 is operable, namely configured. to receive a number of user identifiers (IDs) associated with a number of users (such as the users 102A-102N) present in a network (such as the network 110). The data retrieving module 308 is operable, namely configured, to determine a plurality of matched pairs of user identifiers. In an embodiment, the matched pairs of user identifiers are pre-defined and pre-stored in a database of the computing device 302 or of a remotely located device in the network 110. In an embodiment, the data retrieving module 308 is configured to retrieve the matched pairs of user identifiers from the database 312.

The identity mapping module 310 is operable, namely configured, to compare the determined plurality of matched pairs of user identifiers with each of the received plurality of user identifiers to create a first graph. The first graph may include one or more of the plurality of matched pairs of user identifiers overlapped with the received user identifiers and a similarity score. The similarity score may be determined based on the comparison of the matched pairs of user identifiers with the received user identifiers. In an embodiment, the user identifiers are received from one of the computing devices 104A-104N.

The identity mapping module 310 is further operable, namely configured, to map the user identifiers of the first graph onto at least one single customer view identifier (SCV_ID). Each distinct SCV_ID is mapped to at least one user identifier of the user identifiers. The identity mapping module 210 is further operable, namely configured, to create a second graph based on the mapping of the plurality of user identifiers of the first graph onto the at least one single customer view identifier (SCV_ID). The second graph may include a number of SCV_IDs. In an embodiment, the second graph includes the SCV_IDs such that one or more of the SCV_IDs are in the received user identifiers. In another embodiment, one or more of the user identifiers mapping to a same SCV_ID are not in the second graph.

The identity mapping module 310 is also operable, namely configured, to identify at least one user associated with one or more of the computing devices 104A-104N based on the single customer view identifiers in the second graph.

The functionality and structure of the identity mapping module 310 is similar to the identity mapping module 210 of FIG. 2.

Furthermore, the Input/Output module 314 is operable configured to present or display the second graph on the computing device 302 of a user. For example, the second graph or an output graph may be presented at the computing device 104A of the user 102A. In an embodiment, an SCV_ID of the plurality of SCV_IDs in the second graph represent a single user. Furthermore, one or more user identifiers mapped to the SCV_ID belongs to same user of the users 102A-102N. Furthermore, as used herein, a “memory” refers to a single or multiple modules or devices including hardware, software, firmware, or combination of these that can be configured to store instructions that can be executed by other modules/devices.

The central processing module 318 may include a single or multiple modules or devices including a software, hardware, firmware or combination of these, that is configured to execute instructions stored in the memory 316. The network interfacing module 320 may enable the computing device 302 to establish connection with the network 110 or/and with other network devices such as the computing devices 104A-104N present in the network 110.

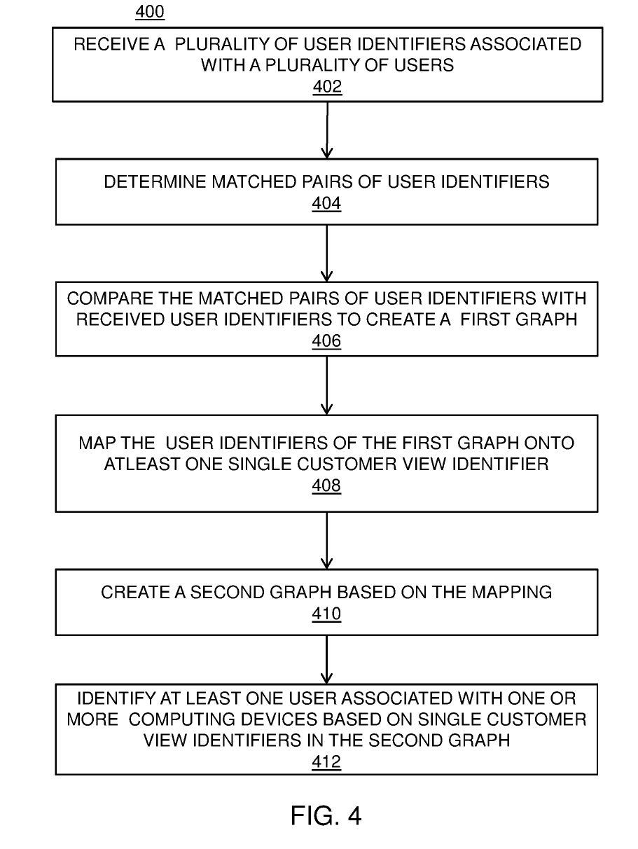

In FIG. 4, there is shown a flowchart illustrating an exemplary method 400 of creating non-overlapping groups of user identifiers representing a single user, in accordance with an embodiment of the present disclosure. The method 400 may be implemented or performed by an identity management system such as, the identity management systems 106A-106C, 204, and 304 as described with reference to FIGS. 1A-1C, 2 and 3. The identity management system may be a single device or may be a combination of multiple devices including software, hardware, firmware, or combination of these. The identity management system may further include following modules or devices i.e., a transceiving module, a database, a data retrieving module, and an identity mapping module. Each of these modules can be a device or a combination of multiple devices. The identity management system may be present or implemented on a computing device or a server or on any network device in the network.

At a step 402, a plurality of user identifiers are received. The user identifiers may be associated with a plurality of users. In an embodiment, the transceiving module receives the user identifiers. Then at a step 404, a number of matched pairs of user identifiers are determined. In an embodiment, the matched pairs of user identifiers are determined from a database such as a database of a server.

At a step 406, the matched pairs of the user identifiers are compared with received user identifiers to create a first graph (or a relevant graph). In an embodiment, the identity mapping module compares the matched pairs of the user identifiers with the received user identifiers to create the first graph and determine similarity score. At a step 408, map the user identifiers of the first graph onto at least one single customer view identifier (SCV_ID). In an embodiment, the identity mapping module maps the user identifiers of the first graph onto at least one SCV_ID. At a step 410, create a second graph based on the mapping done at the step 408. In an embodiment, the identity mapping module creates a second graph based on the mapping. At a step 412, at least one user associated with one or more computing devices is identified based on the SCV_IDs present in the second graph. In an embodiment, the identity mapping module of the identity management system identifies the at least one user associated with the one or more computing devices based on the SCV_IDs present in the second graph.

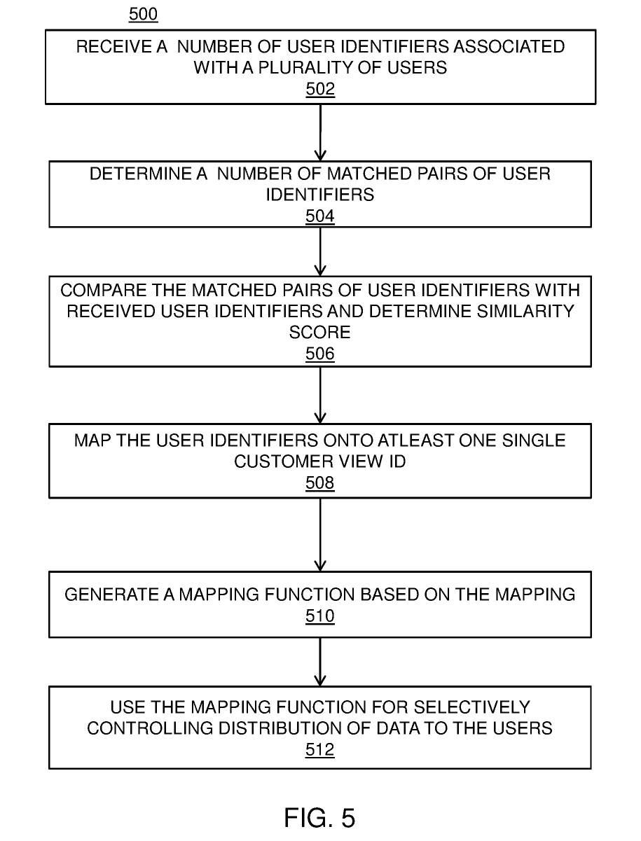

In FIG. 5, there is shown a flowchart illustrating an exemplary method 500 of creating non-overlapping groups of user identifiers representing a single user, in accordance with an embodiment of the present disclosure. In an embodiment, the user identifiers are associated with one or more users, for example the users 102A-102N as described in the foregoing with reference to FIG. 1A, who are either accessing or have accessed a data communication system. The data communication system includes a data communication network (or the network 110). The users may be coupled or connected to the data communication network when the data communication system is in operation. Furthermore, the data communication system may include at least one data server, such as the server 108, for use in implementing the method 500. The users have associated therewith corresponding user identifiers (IDs or UIIDs). The users can interact with the data communication system by using a number of associated user devices, for example computing devices 104A-104N. The method 500 may be implemented or performed by an identity management system such as, the identity management systems 106A-106C, 204, and 304 as discussed with reference to FIGS. 1A-1C, 2 and 3. The identity management system may be a single device or may be a combination of multiple devices including software, hardware, firmware, or combination of these. The identity management system may further include following modules or devices i.e., a transceiving module, a database, a data retrieving module, and an identity mapping module. Each of these modules can be a device or a combination of multiple devices. The identity management system may be present or implemented on a user device or the data server or on any network device in the data communication network.

At a step 502, a number of user identifiers are received. In an embodiment, the transceiving module receives the user identifiers. In an embodiment, the user IDs are received from a computing device/user device. In an alternative embodiment, the user IDs are retrieved from a database of the data server. Then at a step 504, a number of matched pairs of user identifiers are determined. In an embodiment, the matched pairs of user IDs are determined from a database such as the database of the data server.

At a step 506, the matched pairs of the user IDs are compared with each of the received user IDs to determine a similarity score for the matched pairs and the user IDs. In an embodiment, the identity mapping module compares the matched pairs of the user identifiers with each of the received user identifiers to determine one or more similarity scores, for example plurality of similarity scores.

At a step 508, the user IDs are mapped onto at least one single customer view identifier (SCV_ID). A single customer view ID may be based on browsing event including browsing history, timestamp information, uniform resource locators, website information, device ID, images, and such like in a device. Furthermore, multiple users may be mapped onto a single SCV_ID. The single SCV_ID may represent and indicate that the multiple users IDs that are being mapped onto the same SCV_ID belong to a same user. Furthermore, an SCV_ID represent a single user and one or more user identifiers mapped to the SCV_ID belongs to same user of the users.

At a step 510, a mapping function “F” is generated. Furthermore, each customer view identifier is distinctly mapped to at least one user identifier of the plurality of user identifiers to generate a mapping function “F”. Furthermore, in an embodiment, the identity management system maps each single customer view identifier to at least one user identifier of the plurality of user identifiers, to generate a mapping function “F”. A distinct SCV_ID may represent a single unique user and may be based on the browsing event across multiple devices. Multiple user IDs may be mapped to a single distinct SCV_ID. The mapping function “F” may be determined using suitable analysis methods and/or computational methods based on correlation, neural network based methods, multi-dimensional correlation, clustering methods, and so forth. In an exemplary scenario, the mapping function “F” may be determined using one or more multidimensional correlation methods and models to identify relationships between the user devices, single customer view IDs and the user identifiers of the users.

Furthermore, the steps 508 and 510 may be iteratively performed for achieving a distinct mapping in the mapping function “F”. The mapping function “F” may indicate relationship of the user IDs and various device identifiers of the user devices that are being used for accessing the data communication network by multiple users. For example, Kalman Filtering, also known as linear quadratic estimation (LQE), is an algorithm that uses a series of measurements observed over time, containing statistical noise and other inaccuracies, and produces estimates of unknown variables that tend to be more precise than those based on a single measurement alone. The Kalman filter is named after Rudolf Kalman, one of the primary developers of its theory.

Kalman filters have numerous applications in technology. A common application for Kalman filters is for guidance, navigation and control of vehicles, particularly aircraft and spacecraft. Furthermore, Kalman filters are a widely applied concept in time series analysis used in fields such as signal processing and econometrics. Moreover, Kalman filters are also employed for robotic motion planning and control, and they are sometimes included in trajectory optimization. Kalman filter are capable of providing a model needed for making estimates of the current state of a given system and issuing updated commands.

The Kalman filter algorithm works in a two-step process. In a prediction step, the Kalman filter produces estimates of the current state variables, along with their uncertainties. Once the outcome of the next measurement (necessarily corrupted with some amount of error, including random noise) is observed, these estimates are updated using a weighted average, with more weight being given to estimates with higher certainty. The algorithm is recursive. It can run in real time, using only the present input measurements and the previously calculated state and its uncertainty matrix; no additional past information is required.

At a step 512, the mapping function “F” may be used for selectively controlling distribution of data, such as advertising content, surveys, movies, and so forth, to the users. For example, the server may send the advertising content to users 102B, 102C, and 102D or to their associated devices 104B, 104C, and 104D, respectively. In an embodiment, the mapping function and/or the second graph is sent to another device in a network such as another server device connected to the data communication network. Thereafter, the another device may control distribution of data to the users 102A-102N in the network 110. For example, another server device may select few of the users 102A-102N to send a survey on their associated user devices.

In an exemplary scenario, a customer or a client user may want to create non-overlapping groups of user identifiers, which may represent a single user. The customer may want to create this to understand reach of his/her advertising campaign. As a customer of cortex single view, the customer should be able to count the number of individuals who have seen an advertisement. Therefore to identify a single user from a list of user identifiers (UIID) or received user identifiers i.e.

|UIID| |A| |D| |C| |G| |X| |Y| |Z|

Then, based on the input user identifiers, a first graph or a relevant graph including matched pairs overlapped with input user identifiers is created. For example, “#IsSeed true” means a user identifier (or a UIID or ID) is in the received user identifiers set. Similarly, similarity scores for the matched pairs of user identifiers etc. are determined using the following: “|ID(IsSeed)|ID(IsSeed)|similarity score|”. For example, |A(true)|B(false)|High|, |B(false)|C(true)|High|, |A(true)|D(true)|High|, |A(true)|E(false)|High|, |D(true)|E(false)|High|, |F(false)|G(true)|Low|, |F(False)|H(False)|Low|, |F(false)|A(false)|Very Low|

Furthermore, the similarity score may have a numeric value like 0.1, 0.2, 0.5, and so forth based on a probability of the matched pairs and the user identifiers. Such numerical values are suitable for feeding into algorithms, for example the aforementioned Kalman filter, as parameter values.

Based on the first graph a second graph (or an output map or an SCV_Map) may be created or requested. An exemplary output map or second map format may look like “|SCV_ID|Set {UIID 1, UIID 2, . . . UIID N}|”.

If a user identifier provided is in the matched pairs, then it should be in the output map or the second graph. In an embodiment, a user identifier (of the first graph) should only appear against one SCV_ID. And each distinct SCV_ID should be mapped to at least one user identifier from the received user identifiers. But user identifiers with the same SCV_ID must be in a connected graph in the determined matched pairs of user identifiers. But user identifiers with the same SCV_ID don't necessarily have to be a connected graph in the output graph. In addition, singletons, an SCV_ID mapped to a single user identifier mapped to a single user identifier can be returned. Moreover, there may not be any user identifiers which are not in the matched pairs of user identifiers.

In another exemplary scenario, |Type| |cookie| |device ids| |device ids| @NegativeTest Scenario: Provided UIIDs are not in device graph

In an exemplary scenario, when some data is received from the customer:

|UIID| |H| |I| |J| |K|

And the following matched pairs:

|ID (isSeed)|ID (isSeed)|similarity_score |
|A (true)|B (false)|High|
|B (false)|C (true)|High|
|A (true)|D (true)|High|
|A (true)|E (false)|High|
|D (true)|E (false)|High|
|F (false)|G (true)|Low|
|F(false)|H (false)|Low|
|F (false)|A (false)|Very Low|
When the disclosed method is executed, then following output is presented on the computing device: |SCV_ID|UIIDs| |empty|empty |#log file,

The disclosed method may be implemented when an input is a mixture of Ids or UIIDs, some of which are the matched pairs some are not.

The disclosed method may also be used to return a same single customer view if UIID is in the same cluster multiple times.

The present disclosure provides multi-staged, clustering methods to first derive data aggregate data from one or more data sources, and then via clustering, group those together into a unified output. Whether the output is for Single Consumer View, or to provide a means to provide aggregate views for demographics, time, geographies, and other critical data elements is now also possible, via a multistage approach to extract the core data (beyond ETL, this is to put into use for disclosed methods), getting one result set from the extraction, and using the extraction, or combination of extractions to provide a secondary result that would not be possible without first examining and providing contextual understanding to the initial data result.

Various companies may use the disclosed methods and systems for frequency capping or planning their marketing campaigns.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A method of controlling data flows within a data communication system, wherein the data communication system includes a data communication network to which a plurality of users are coupled when the data communication system is in operation, wherein the data communication system includes at least one data server for use in implementing the method, wherein the plurality of users have associated therewith corresponding user identifiers (IDs), and wherein the plurality of users interact with the data communication system by using a plurality of user devices, wherein the method comprising steps of:
(i) receiving the plurality of user identifiers (IDs);
(ii) determining a plurality of matched pairs (P) of the user identifiers (IDs);
(iii) comparing the determined plurality of the matched pairs (P) of the user identifiers (IDs) with each of the received plurality of user identifiers (IDs), and determining a similarity score for the matched pairs and the user identifiers (IDs);
(iv) mapping the plurality of user identifiers (IDs) onto at least one single customer view identifier (SCV_ID), wherein each single customer view identifier (SCV_ID) is distinctly mapped to at least one user identifier (ID) of the plurality of user identifiers (IDs), to generate a mapping function (F); and
(v) using the mapping function for selectively controlling distribution of data content to the plurality of users.

2. The method of claim 1, wherein the steps (iii) and (iv) are performed iteratively for achieving a distinct mapping in the mapping function.

3. The method of claim 1, wherein comparing the determined plurality of matched pairs of user identifiers with each of the received plurality of user identifiers includes creating a first graph, wherein the first graph comprises one or more of the plurality of matched pairs of user identifiers overlapped with the received plurality of user identifiers and a similarity score, wherein the similarity score is determined based on the comparison of the matched pairs of user identifiers with the plurality of user identifiers.

4. The method of claim 1 further comprising:
mapping the plurality of user identifiers of the first graph onto at least one single customer view identifier, wherein each distinct single customer view identifier is mapped to at least one user identifier of the plurality of user identifiers; and
creating a second graph based on the mapping of the plurality of user identifiers of the first graph onto the at least one single customer view identifier, the second graph comprises a plurality of single customer view identifiers, wherein each single customer view identifier of the plurality of single customer view identifiers in the second graph represent a single user and one or more user identifiers mapped to the single customer view identifier belongs to same user of the plurality of users.

5. The method of claim 4 further comprising presenting the second graph on a computing device of a user, wherein a single customer view identifier of the plurality of single customer view identifiers in the second graph represent a single user and one or more user identifiers mapped to the single customer view identifier belongs to same user of the plurality of users.

6. The method of claim 5, wherein the second graph comprises a plurality of single customer view identifiers, wherein one or more of the plurality of single customer view identifiers are in the received plurality of user identifiers.

7. The method of claim 6, wherein one or more of the plurality of user identifiers mapping to a same single customer view identifier are absent in the second graph.

8. The method of claim 7, wherein the plurality of matched pairs of user identifiers are pre-defined and pre-stored in a database of the server.

9. The method of claim 8 further comprising arranging for the data communication system to employ the Internet as a part of its data communication network.

10. A data communication system for controlling data flows, wherein the data communication system includes a data communication network to which a plurality of users are coupled when the data communication system is in operation, wherein the data communication system includes at least one data server for use in implementing the method, wherein the plurality of users have associated therewith corresponding user identifiers, and wherein the plurality of users interact with the data communication system by using a plurality of user devices, wherein the data communication system is operable to:
(i) receive the plurality of user identifiers;
(ii) determine a plurality of matched pairs of the user identifiers;
(iii) compare the determined plurality of the matched pairs of the user identifiers with each of the received plurality of user identifiers, and determining a similarity score for the matched pairs and the user identifiers;
(iv) map the plurality of user identifiers onto at least one single customer view identifier, wherein each customer view identifier is distinctly mapped to at least one user identifier of the plurality of user identifiers, to generate a mapping function; and
(v) use the mapping function for selectively controlling distribution of data content to the plurality of users.

11. The data communication system of claim 10, wherein the data communication system is operable to perform (iii) and (iv) iteratively for achieving a distinct mapping in the mapping function.

12. The data communication system of claim 11, wherein the data communication system, when comparing the determined plurality of matched pairs of user identifiers with each of the received plurality of user identifiers, is operable to create a first graph, wherein the first graph comprises one or more of the plurality of matched pairs of user identifiers overlapped with the received plurality of user identifiers and a similarity score, wherein the similarity score is determined based on the comparison of the matched pairs of user identifiers with the plurality of user identifiers.

13. The data communication system of claim 12, wherein the data communication system is operable to:
map the plurality of user identifiers of the first graph onto at least one single customer view identifier, wherein each distinct single customer view identifier is mapped to at least one user identifier of the plurality of user identifiers; and
create a second graph based on the mapping of the plurality of user identifiers of the first graph onto the at least one single customer view identifier, the second graph comprises a plurality of single customer view identifiers, wherein each single customer view identifier of the plurality of single customer view identifiers in the second graph represent a single user and one or more user identifiers mapped to the single customer view identifier belongs to same user of the plurality of users.

14. The data communication system of claim 13, wherein the data communication system is operable to present the second graph on a computing device of a user, wherein a single customer view identifier of the plurality of single customer view identifiers in the second graph represent a single user and one or more users mapped to the single customer view identifier belongs to same user of the plurality of users.

15. The data communication system of claim 14, wherein the second graph comprises a plurality of single customer view identifiers, wherein one or more of the plurality of single customer view identifiers are in the received plurality of user identifiers.

16. The data communication system of claim 15, wherein one or more users of the plurality of user identifiers mapping to a same single customer view identifier are absent in the second graph.

17. The data communication system of claim 14, wherein the data communication system method is operable to present the second graph to the user on a computing device associated with the user.

18. The data communication system of claim 17, wherein the plurality of matched pairs of user identifiers are pre-defined and pre-stored in a database of the server.

19. The data communication system of claim 18, wherein the data communication system is operable to employ the Internet as a part of its data communication network.

20. A non-transitory tangible computer readable medium comprising instructions for the execution of the method according to claim 1.

21. A method of identifying relationship between a plurality of users and a plurality of devices connected to a network, the method comprising:
at a server:
receiving, by a transceiving module, a plurality of user identifiers (IDs) associated with the plurality of users present in the network;
determining, by a data retrieving module, a plurality of matched pairs of user identifiers;
comparing, by an identity mapping module, the determined plurality of matched pairs of user identifiers with each of the received plurality of user identifiers to create a first graph, wherein the first graph comprises one or more of the plurality of matched pairs of user identifiers overlapped with the received plurality of user identifiers and a similarity score, wherein the similarity score is determined based on the comparison of the matched pairs of user identifiers with the plurality of user identifiers;
mapping, by the identity mapping module, the plurality of user identifiers of the first graph onto at least one single customer view identifier, wherein each distinct single customer view identifier is mapped to at least one user identifier of the plurality of user identifiers;
creating, by the identity mapping module, a second graph based on the mapping of the plurality of user identifiers of the first graph onto the at least one single customer view identifier, the second graph comprises a plurality of single customer view identifiers, wherein each single customer view identifier of the plurality of single customer view identifiers in the second graph represent a single user and one or more user identifiers mapped to the single customer view identifier belongs to same user of the plurality of users; and
identifying, by the identity mapping module, at least one user associated with one or more of the plurality of computing devices based on the plurality of single customer view identifiers in the second graph, wherein the at least one single customer view identifier comprises browsing event including at least one of browsing history, timestamp information, images, uniform resource locators, images, cookie information, and device identifier.

22. The method of claim 21, wherein the second graph comprises a plurality of single customer view identifiers, wherein one or more of the plurality of single customer view identifiers are in the received plurality of user identifiers.

23. The method of claim 21, wherein one or more of the plurality of user identifiers mapping to a same single customer view identifier are absent in the second graph.

24. The method of claim 23, wherein the second graph is presented to the user on an associated computing device.

25. The method of claim 24, wherein the plurality of matched pairs of user identifiers are pre-defined and pre-stored in a database of the server.

26. A system for identifying relationship between a plurality of users and a plurality of devices connected to a network, the system comprising:
a server comprising:
a transceiving module configured to receive a plurality of user identifiers (IDs) associated with the plurality of users present in the network;
a data retrieving module configured to determine a plurality of matched pairs of user identifiers; and
an identity mapping module configured to:
compare the determined the plurality of matched pairs of user identifiers with each of the received plurality of user identifiers to create a first graph, wherein the first graph comprises one or more of the plurality of matched pairs of user identifiers overlapped with the received plurality of user identifiers and a similarity score, wherein the similarity score is determined based on the comparison of the matched pairs of user identifiers with the plurality of user identifiers;
map the plurality of user identifiers of the first graph onto at least one single customer view identifier, wherein each distinct single customer view identifier is mapped to at least one user identifier of the plurality of user identifiers;
create a second graph based on the mapping of the plurality of user identifiers of the first graph onto the at least one single customer view identifier, the second graph comprises a plurality of single customer view identifiers, wherein each single customer view identifier of the plurality of single customer view identifiers in the second graph represent a single user and one or more user identifiers mapped to the single customer view identifier belongs to same user of the plurality of users; and
identify, by the identity mapping module, at least one user associated with one or more of the plurality of computing devices based on the plurality of single customer view identifiers in the second graph, wherein the at least one single customer view identifier comprises browsing event including at least one of browsing history, timestamp information, images, uniform resource locators, images, cookie information, and device identifier.
